(19) United States
(12) Patent Application Publication
(10) Pub. No.: US 2014/0316958 A1
(43) Pub. Date: Oct. 23, 2014

(54) SYSTEMS, DEVICES, AND METHODS FOR ENERGY ACCOUNT MANAGEMENT

(71) Applicant: GREEN EDGE TECHNOLOGIES, INC., Poway, CA (US)

(72) Inventors: William P. Alberth, JR., Prairie Grove, IL (US); William Rice, San Diego, CA (US); David K. Hartsfield, Poway, CA (US)

(73) Assignee: Green Edge Technologies, Inc., Poway, CA (US)

(21) Appl. No.: 13/865,076

(22) Filed: Apr. 17, 2013

(51) Int. Cl. G06Q 20/14

(52) U.S. Cl. CPC G06Q 20/145
USPC 705/35

(57) ABSTRACT

A method for tracking a quantity of a utility supplied to a device connected to a utility supply associated with a first account of the utility is disclosed. The method may include determining if the device is associated with a second account, and associating the quantity of the utility consumed by the device to the second account if the device is associated with the second account.

### FIELD OF THE INVENTION

Embodiments of the present disclosure are directed to systems, devices, and methods for automating the management of energy accounts. More particularly, the present disclosure is directed to determining different accounts that future energy consumption should be charged against, and tracking the consumption of energy or a utility on, e.g., a user-by-user basis.

### BACKGROUND OF THE INVENTION

Typically, if a user, such as a friend, visits a primary account-holder, such as homeowner's home, and plugs a computer or cell phone into an outlet to charge a battery, the homeowner accepts this behavior and restitution for the utility consumed is often not discussed. As energy costs increase and electric cars become increasingly popular, this behavior may need to be modified if the energy drawn to power or charge a visitor's device is not insignificant. While a homeowner may be willing to pay the cost to charge a friend's cell phone, the homeowner may want compensation for allowing a friend to charge his electric car, which may draw significantly larger amounts of energy and thereby increase the cost of energy to the homeowner.

In addition, peak power usage is a significant concern of utilities providing electrical power. It is well known to provide utility-controlled circuit breakers to permit the utility to disable some of the air conditioning compressors or other large energy-consuming devices in an operating area to prevent the multiple devices from running at the same time, such as during a very hot day. Rolling lock outs of compressors reduce the peak power drawn from the power grid and permit the utility to keep up with the demand. Some communities may source significant portions of their power from a fixed supply such as wind, solar, or thermal. Therefore the peak power usage of a home owner must not be allowed to exceed what the fixed supply can provide.

What is needed is a method to permit a user to compensate a primary account-holder for the power used to charge his phone, computer, car, or other energy-drawing device, and a method to allow the primary account-holder to dynamically choose which devices are operated while staying within peak power, average power, or allocated power limits.

### SUMMARY OF THE INVENTION

The present disclosure is generally directed to systems and methods of controlling usage and charges from a utility. More particularly, the present disclosure may include systems, devices, and methods for intelligently controlling one or more energy-consuming devices and/or other components in a structure such as a residential, commercial, or industrial building. The structures may be multi-unit buildings such as a strip mall, a condominium, an apartment building, a townhouse, or an office building.

In one embodiment, the present disclosure includes a method of determining a maximum amount of a utility that can be consumed, and controlling devices that consume the utility to prevent the maximum amount from being exceeded.

Various embodiments of the method may include one or more of the following features: the allowed usage amount may include at least one of a peak or average usage; the allowed usage amount may change with time of day, or date; the allowed usage amount may change during an energy action alert; the allowed usage may be sent to a home automation system via an electronic message from the utility provider or an agent of the utility provider.

In another embodiment, the present disclosure may include an automation system with a control unit, one or more remote switches, and one or more remote outlets. The remote outlets may be in a building served by a utility which may be registered to one or more accounts. Devices plugged into or otherwise coupled to the outlet may draw on the utility and appropriately charge to at least one of the accounts. If a person not associated with an established account plugs a device into an outlet, the power drawn may be charged to an account associated with that user.

In another exemplary embodiment, the home automation system may determine that a set of two or more outlets are sourced power by a common set of wires. The home automation system may control power consumption by the set of outlets to prevent the common wires from being overloaded.

In another exemplary embodiment, a delivered utility may be metered at the outlet where the appliance is plugged in. A building may have multiple outlets or utility delivery devices, each of which may be individually assigned to an account.

Embodiments of the present disclosure may be directed to systems, devices, and methods for intelligently controlling and tracking one or more energy consuming devices in a structure including, but not limited to, a home, office, hospital, sporting complex, or school and associating a usage of a utility with an account.

While the embodiments often use electric power as an example, the methods are expected to apply to other utilities and resources such as: steam; water; natural gas; liquid propane gas (LPG), or other utilities.

Various embodiments of the automation system may include one or more of the following features: an outlet including an adaptor configured to be operably coupled with a preexisting electrical outlet; at least one sensor, e.g., a plurality of sensors; the at least one sensor may include one of a motion sensor, light sensor, and a temperature sensor; the outlet may include a microprocessor; one of the control unit and microprocessor may be configured to receive power consumption data for one or more electrical devices from a power monitor; one of the control unit and microprocessor may be configured to compare the received power consumption data to power consumption data of known electrical devices; one of the control unit and microprocessor may be configured to identify the one or more electrical devices based on the comparison of the received power consumption data to power consumption data of known electrical devices; the at least one outlet may be configured to detect an electrical noise in a power line generated by the one or more electrical devices; the at least one outlet may be configured to communicate the detected electrical noise to the control unit; the control unit may be configured to compare the detected electrical noise to electrical noise data of known electrical devices; the control unit may be configured to identify the one or more electrical devices based on the comparison of the detected electrical noise to electrical noise data of known electrical devices; the sensor may be configured to detect a radiofrequency signal; a switch operably coupled to the controller and the outlet; the control unit may be configured to communicate with the Internet; the communication link may be configured to allow wireless communication between the outlet and the control unit; and the control unit may be configured to terminate delivery of electrical energy to the at least one outlet based on an input from the at least one sensor.

The present disclosure may be generally directed to systems and methods for controlling power in a Smart home. More particularly, the present disclosure may include systems, devices, and methods for intelligently controlling one or more energy-consuming devices in a structure such as a residential, commercial, or industrial building. One embodiment may include a method of identifying a device as not belonging to the utility account owner, and charging use of the device to a different account owned by the device.

In one embodiment, the present disclosure is directed to a method for tracking a quantity of a utility supplied to a device connected to a utility supply associated with a first account of the utility. The method may include determining if the device is associated with a second account of the utility, and associating the quantity of the utility consumed by the device to the second account if the device is associated with the second account. The method may also include associating the quantity of the utility consumed by the device to the first account if the device is not associated with the second account.

Various embodiments of the disclosure may include one or more of the following aspects: sending data representing the quantity of the utility consumed from the utility supply and associated with both the first and second accounts to a utility provider; transferring funds from a holder of the second account to a holder of the first account if the device is associated with the second account; wherein the utility supply is controlled by a first account holder; utility consumed through the power supply is associated with the first account by default; and the device is controlled by a second account holder; wherein the device is an electric-powered vehicle and the utility is electrical energy; wherein determining if the quantity of the utility consumed by the device is associated with the second account further includes receiving information about the device, the second account, or a user of the device; receiving information about the device, the second account, or the user of the device transmitted by a manual input receiving information about the device, the second account, or the user of the device transmitted by the device via a wireless connection; and wherein a device associated with the first account is located within a first unit of a multi-unit structure and a device associated with the second account is located within a second unit of the multi-unit structure.

In another embodiment, the present disclosure is directed to a system for tracking a utility supplied to a device connected to a utility supply associated with a first account of the utility. The system may include a controller connected to the utility supply. The controller may be configured to determine if the device is associated with a second account of the utility, and associate the quantity of the utility consumed by the device to the second account if the device is associated with the second account. The controller may also be configured to associate the quantity of the utility consumed by the device to the first account if the device is not associated with the second account.

Various embodiments of the disclosure may include one or more of the following aspects: wherein the controller is further configured to send data representing the quantity of the utility consumed from the utility supply and associated with both the first and second accounts to a utility provider; wherein the utility supply is controlled by a first account holder, utility consumed through the power supply is associated with the first account by default, and the device is controlled by a second account holder; and wherein determining if the quantity of the utility consumed by the device is associated with the second account further includes receiving information about the device, the second account, or a user of the device.

In yet another embodiment, the present disclosure is directed to a method of limiting utility usage. The method may include receiving a usage limit, and receiving a request to access the utility. The method may also include determining if granting the request will cause a usage total to exceed the usage limit, and granting access to the utility if the request will not cause the usage total to exceed the usage limit. The method may also include denying access to the utility if the request will cause the usage total to exceed the usage limit.

Various embodiments of the disclosure may include one or more of the following aspects: wherein the usage limit is at least one of a peak usage, an average usage, an allocated usage, and a maximum load supportable by a delivery circuit; denying all requests to access the utility if the usage total exceeds the usage limit; wherein the allocated usage limit is a limit set by an authority figure for a usage total consumed by a subordinate figure; wherein the authority figure sets a plurality of allocated usage limits for a corresponding number of subordinate figures; determining if a first device is consuming the utility, and decreasing access of the first device to the utility if the request for accessing the utility is made by a second device; decreasing access of the first device to the utility if the usage total is below the usage limit after both the second device is allowed to draw on the utility and the access of the first device to the utility is decreased; decreasing access of the first device to the utility if the second device is assigned an operating priority over the first device; granting access to the utility on a time delay if granting the request immediately will cause the usage total to exceed the usage limit but granting the request after the time delay will not cause the usage total to exceed the usage limit; and prohibiting decreasing access of the first device to the utility if the first device determined to require an uninterrupted utility supply.

In yet another embodiment, the present disclosure is directed to a system for limiting utility usage. The system may include a controller configured to receive a usage limit, and receive a request to access the utility. The controller may also be configured to determine if granting the request will cause a usage total to exceed the usage limit, and grant access to the utility if the request will not cause the usage total to exceed the usage limit. The controller may also be configured to deny access to the utility if the request will cause the usage total to exceed the usage limit.

Various embodiments of the disclosure may include one or more of the following aspects: wherein the usage limit is at least one of a peak usage, an average usage, an allocated usage, and a maximum load supportable by a delivery circuit; wherein the controller is further configured to determine if a first device is consuming the utility, and decrease access of the first device to the utility if the request for accessing the utility is made by a second device; and wherein the controller is further configured to decrease access of the first device to the utility if the usage total is below the usage limit after both the second device is allowed to draw on the utility and the access of the first device to the utility is decreased.

It may be understood that both the foregoing general description and the following detailed description are exemplary and explanatory only, and are not restrictive of the disclosure, as claimed. The present disclosure will be more clearly understood from the detailed description below in conjunction with the accompanying drawings.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 schematically illustrates an exemplary automation system, in accordance with an embodiment of the present disclosure.

FIG. 2 schematically illustrates an exemplary switch, in accordance with an embodiment of the present disclosure.

FIG. 3 schematically illustrates an exemplary outlet, in accordance with an embodiment of the present disclosure.

FIG. 4 is a flow diagram of an exemplary method, in accordance with an embodiment of the present disclosure.

FIG. 5 shows a flow diagram of an exemplary method to limit maximum usage of a resource, in accordance with an embodiment of the present disclosure.

FIG. 6 shows a flow diagram of an exemplary method to limit usage of a particular circuit, in accordance with an embodiment of the present disclosure.

FIG. 7 shows an exemplary electrical distribution scheme to a multi-unit structure.

FIG. 8 shows an exemplary electrical distribution scheme to outlets in a multi-unit structure.

FIG. 9 shows electrical distribution to a multi-unit structure, in accordance with an embodiment of the present disclosure.

FIG. 10 shows electrical distribution to outlets in a multi-unit structure, in accordance with an embodiment of the present disclosure.

### DETAILED DESCRIPTION

Reference now will be made in detail to embodiments of the present disclosure, examples of which are illustrated in the accompanying drawings. Wherever possible, the same reference numbers will be used throughout the drawings to refer to the same or like parts and/or components.

### Overview

An automation system, e.g., a home automation system, may include one or more switches and one or more outlets, with the user selectively desiring which outlet or outlets, or other power delivery/consumption components are controlled by the switch(es). Existing X10 systems require a user to manually set an address on a switch and an outlet for which control of the outlet by the switch would be desired. The outlet would then respond to a correspondingly programmed switch or switches with an identical address. The switch may be configured to selectively control delivery of electrical energy to the programmed outlet.

Embodiments of the present disclosure include, among other things, an automation system. Examples of suitable systems and components thereof include those described in U.S. application Ser. No. 13/672,534, filed Nov. 8, 2012, the entire disclosure of which is incorporated by reference herein. Systems according to the present disclosure may be used in, e.g., residential, commercial, educational, and/or industrial structures. Non-limiting examples include single-family and multi-family dwellings, condominium units, apartments, apartment buildings, offices, office buildings, schools, churches or other places of worship, sporting complexes, shopping centers, and manufacturing facilities.

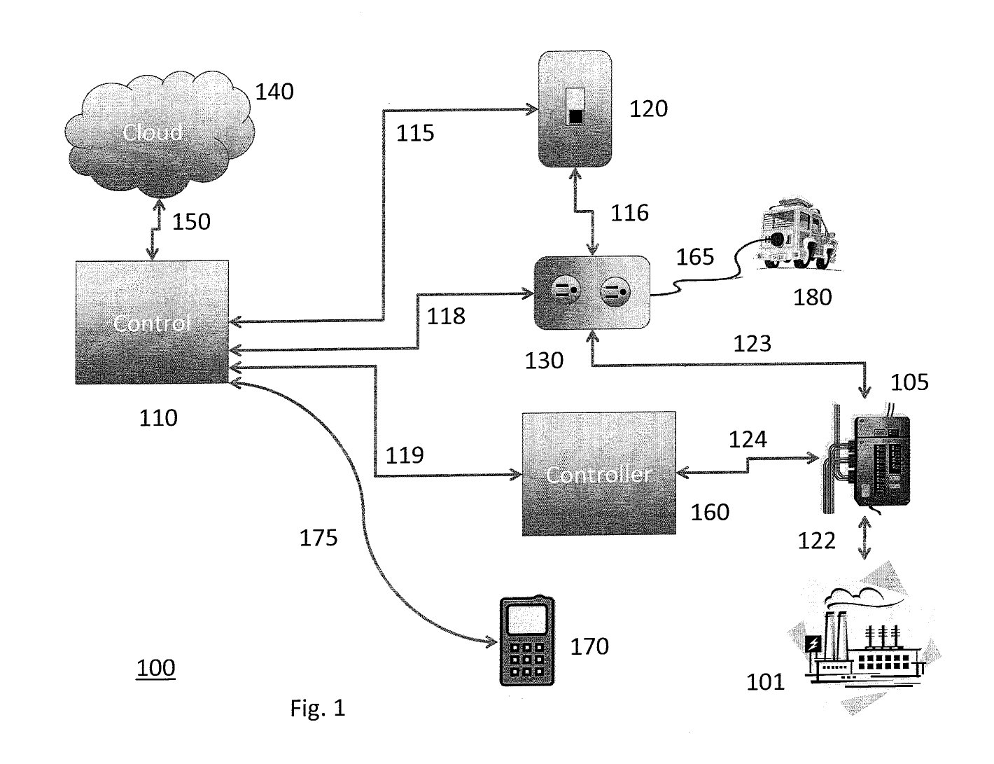

The present disclosure allows for determining the identity of a device plugged into an outlet, determine if the device belongs to the existing account being charged for use of the utility, and if the device does not belong, determining an appropriate account to charge the usage of a utility by the device. The embodiments of the present disclosure may be further understood with reference to FIGS. 1-10. In the embodiment shown in FIG. 1, for example, an automation system 100 includes at least one outlet 130, which can be locally or remotely controlled by, e.g., a switch 120, as discussed below. The outlet 130 may be configured to monitor the power consumed by one or more devices (e.g., appliances) or loads connected to the outlet and/or selectively control power delivered by the outlet 130 to the devices or loads connected thereto. The system 100 may further include switch 120, which may send a signal (e.g., a wireless or wired signal) to a control unit 110. The control unit 110 may also be locally or remotely controlled and may include, for example, a computer with a microprocessor, memory, and user interface. The control unit 110 may be a discrete control unit, such as, e.g., a laptop, desktop, tablet, or any other suitable device, including, e.g., an application configured to be loaded on a mobile device. The control unit 110 may be connected via wired or wireless network connection 150 to the Internet cloud 140. The control unit 110 may be also connected to the switch 120 via wired or wireless connection 115, and further connected to the outlet 130 via wired or wireless connection 118. Similarly, the switch 120 may be connected to the outlet 130 via wired or wireless connection 116. Each of the control unit 110, Internet cloud 140, switch 120, and outlet 130 may include one or more features of the similar components disclosed in U.S. application Ser. No. 13/672,534, filed Nov. 8, 2012, the entire disclosure of which is incorporated by reference herein. Those skilled in the art that the outlet may comprise a device that is included in a junction box or coupled to an electrical system and provides power or another utility or resource to a device. By way of example, this could be a device included in a ceiling junction box that is coupled (e.g., wired) to a ceiling fan, a device included inline to power outside flood lights, a device that monitors and/or controls the flow of natural gas to a furnace, among other variations.

The system 100 may include other components or enhancements. For example, referring to FIG. 1, the automation system 100 may include a controller 160 that can control (e.g., adjust, open, close) window coverings. Controller 160 may be also configured to control other systems or enhancements associated with a home, office, school, or other structure. For example, controller 160 may control systems for irrigation, heating and cooling, entertainment, and/or water heating. In addition, controller 160 may control one or more safety systems. In the embodiment where controller 160 may control window treatments, for example, the controller 160 may receive instructions from the control unit 110 via wired or wireless connection 119. The switch 120 may also communicate with the controller 160 via wired or wireless means (not shown). The wired or wireless connections, for example 115, 116, 118, and 119, may use the same or different protocols or standards. In addition to instructions being processed by control unit 110, some or all of the processing could be performed by one or more microprocessors included in the switch 120, in the cloud 140, in controller 160, or the outlet 130. It is understood that the system 100 may include multiple switches 120, outlets 130, and/or controllers 160, e.g., window control units. Other devices such as moisture sensors may be attached to the system 100 to provide information on the presence of water or rain. The automation system 100 may be also coupled to any number of suitable sensors, including, but not limited to, temperature sensors, light sensors, sounds sensors, heat sensors, motion sensors, and the like. The outlet 130, switch 120, control unit 110, and controller 160 may include one or more features of the outlet, switch, control, and controller described in U.S. application Ser. No. 13/672,534, filed Nov. 8, 2012, which is incorporated herein by reference.

With continued reference to FIG. 1, one or more mobile devices 170 (e.g., a mobile phone, tablet, or phablet) may connect to the control 110 via a wired or wireless connection 175. For example, the mobile device 170 may be connected to the control unit 110 as shown in FIG. 1, or may be also connected to the outlet 130, controller 160, switch 120, another device connected to the automation system 100, or any combinations thereof. The mobile device 170 may include a transceiver, which provides means to measure received signal strength. The mobile device may include any suitable means of collecting, recording, analyzing, and/or transmitting data in order to locate, characterize, and/or otherwise identify devices and components of an automation system. In some embodiments, for example, the mobile device 170 includes an imaging device, e.g., a camera, for taking pictures which may be transmitted to, e.g., automation system 100. The mobile device 170 also may include means for determining location and/or orientation information. Non-limiting examples of such technology include GPS, accelerometers, compasses, and gyroscopes. The mobile device 170 may collect data to determine the orientation of the camera when taking a picture, e.g., whether the camera is pointed towards a ceiling, a floor, or a wall. The geographic location and cardinal direction of the camera may also be determined via a compass, GPS, and/or other suitable data collected by the mobile device 170. In addition to instructions being processed by control unit 110, some or all of the processing could be performed by mobile device 170.

Power (e.g., electrical energy) may be generated at power plant 101, and transmitted to a breaker box 105 via, for example wired transmission lines 122. Breaker box 105 may additionally or alternatively include a cut off switch, a meter, a breaker box, a fuse, a circuit breaker, or any combination thereof. Power may be routed to the outlet 130 by wires 123, and to controller 160 via wires 124. The methods and principles of this specification can also be applied to other utilities such as water, natural gas, steam, heat, or any other utility or resource for which a subscription or other account is required. It is also expected that power could be transmitted wirelessly and that some or all of wires 122, 123, and/or 124 could be replaced with wireless transmission methods.

Breaker box 105 may include a utility meter that may be wired or wirelessly connected to automation system 100. The breaker box 105 may include one or more sensors (not shown) such as a voltage meter, current meter, temperature sensors, etc., that may allow for measurements to be taken on each power line in or out of breaker box 105. The sensors may be wired or wirelessly connected to the automation system 100, and the data may also be available to the provider of the utility, as well as the account holder (e.g., the homeowner).

A vehicle 180, e.g., an electric car, may be coupled to an outlet 130 through wired or wireless connection 165. While the vehicle 180 may be an electric car, it may also be a hybrid, conventional gas powered vehicle, or another suitably powered vehicle. The power drawn from outlet 130 may be used to recharge vehicle 180, power a block heater, or used for another purpose. The vehicle 180 may be able to communicate with system 100 or to another entity, and may have the ability to measure how much power is drawn from outlet 130 to, for example, recharge its batteries.

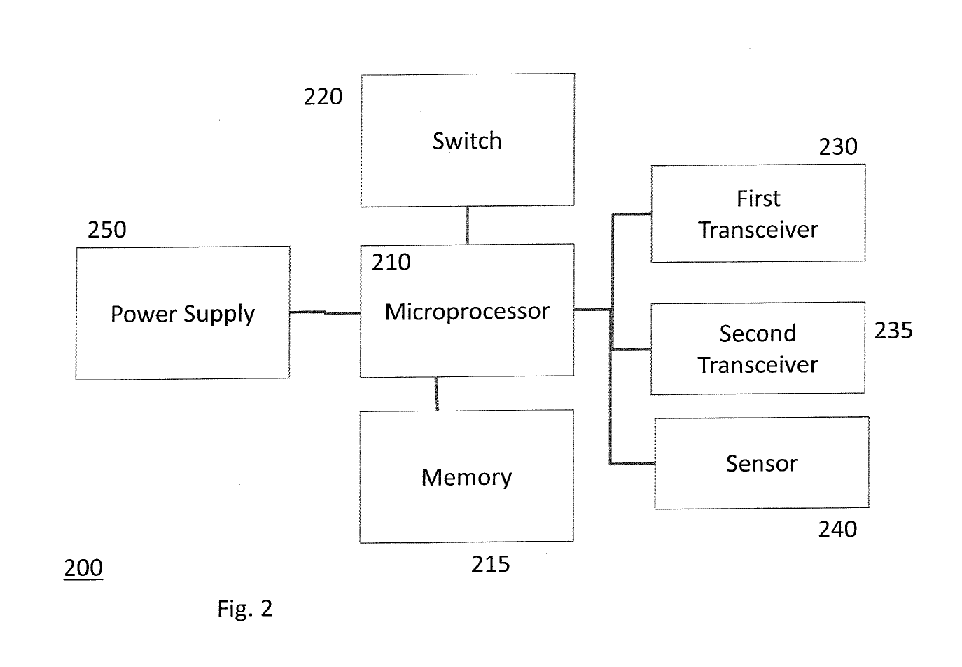

FIG. 2 is a block diagram of an exemplary switch 200 that may be used in conjunction with the automation system 100 and may operate as the switch 120 in FIG. 1. In at least some embodiments, the switch 200 may be remotely controlled by, e.g., control 110. As alluded to above, switch 200 may include any of the features of the switch(s) disclosed in U.S. application Ser. No. 13/672,534, filed Nov. 8, 2012, the entire disclosure of which is incorporated by reference herein. For example, the switch 200 may include a microprocessor 210 capable of running software or an algorithm stored in memory 215. Memory 215 may be any suitable solid state or flash memory. The switch 200 may include a user-operated portion 220, which may be a mechanical light switch, or any of various user input devices known in the art such as, e.g., a touch sensor or push buttons. User-operated portion 220 may be configured to control (e.g., interrupt, adjust, change, terminate and/or meter) the supply of electrical energy to a device or outlet 130 (referring to FIG. 1) in communication with switch 200. Accordingly, in one embodiment, the user-operated control portion 220 may be configured to transition between an “on” position and an “off” position. In another embodiment, the switch may allow various levels to be indicated by the user discretely or continuously. For example, the switch may include a dimming function.

The switch 200 may further include a first transceiver 230, for example, an 802.11 Wi-Fi transceiver. The term “transceiver” as used herein should not be construed as limited to any particular structural components. Instead, a transceiver may include any structural components configured to allow for one or both of back and forth communication. Accordingly, the transceivers disclosed herein may include, but are not limited to, antennae, power supplies, communication ports, and any other elements needed to achieve the desired function. The first transceiver 230 may be configured to communicate over any known protocol including, but not limited to, X10, Zigbee®, and/or Bluetooth. Further, although the exemplary embodiment of FIG. 2 depicts the transceiver 230 as a wireless transceiver, those of ordinary skill will readily recognize that first transceiver 230 may be replaced with a wired communication mode. First transceiver 230 may allow the switch 200 to communicate with a control device, e.g., the control unit 110 as shown in FIG. 1. The first transceiver 230 therefore may allow the switch 200 to exchange commands with the control unit 110 of the automation system 100.

In some embodiments, the switch 200 may also include a second transceiver 235 to allow the switch 200 to communicate with one or more devices (e.g., the outlet 130 shown in FIG. 1 or any electrical load coupled thereto) using multiple standards. Both transceivers 230 and 235 may include received signal-strength indicator means to identify the strength of a signal received by the transceiver(s). The first and second transceivers 230, 235, respectively, may allow for communication over one or more protocols. In addition, the first transceiver 230 may be configured to communicate over a protocol that is different from the communication protocol of the second transceiver 235. Further, in embodiments where only one transceiver (e.g., first transceiver 230) is provided, that single transceiver may be configured to additionally or alternatively perform the functions of second transceiver 235.

The switch 200 may include one or more sensors 240 configured to detect and respond to various conditions or stimuli including, but not limited to temperature, moisture (e.g., water, rain, or humidity), light, sound, air flow, contaminants, motion, or electromagnetic or radio frequencies. Examples of such sensors are disclosed in U.S. application Ser. No. 13/672,534, which is incorporated herein by reference. The switch 200 may also include a power supply 250, which may be any suitable power supply known in the art. In some embodiments, for example, the power supply 250 includes a battery, e.g., a rechargeable battery. It is understood that the power supply 250 in FIG. 2 may schematically illustrate a wired or wireless connection to a power network, such as, e.g., a power grid or transformer. Further, the power supply 250 may include both a battery and a connection to a power network.

The switch 200 may include a microprocessor 210, which may be any suitable microprocessor known in the art. Although FIG. 2 shows the microprocessor 210 located within the switch 200, the microprocessor 210 may additionally and/or alternatively be remotely connected to the switch 200. The microprocessor 210 may be configured to communicate, e.g., exchange control signals, with the one or more sensors 240, the first transceiver 230, the second transceiver 235, memory 215, and/or the user-operated portion 220.

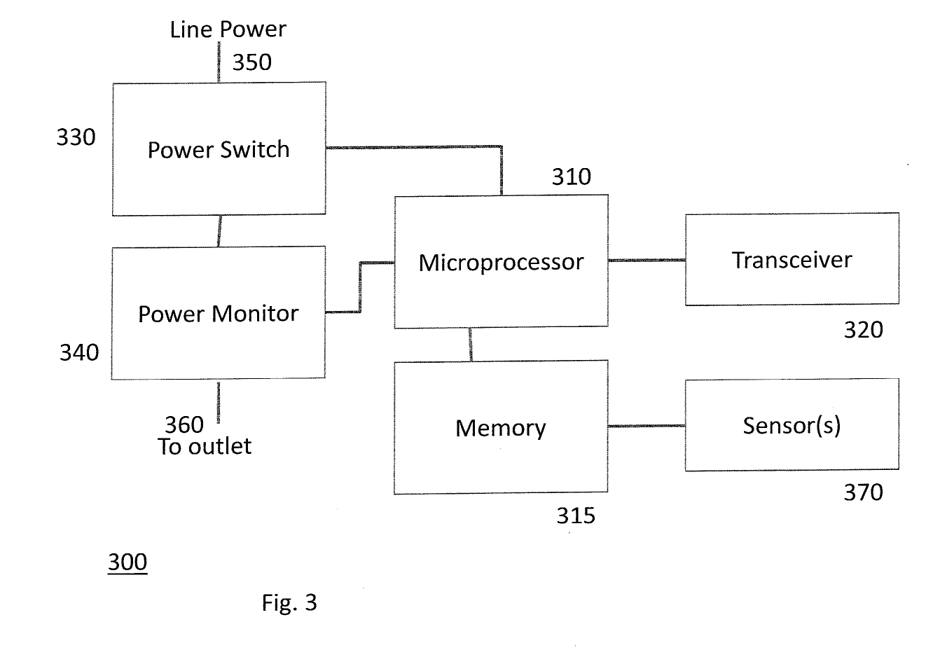

FIG. 3 shows a block diagram of an outlet 300 that may operate as the outlet 130 of the system 100 shown in FIG. 1. In at least some embodiments, the outlet 300 may be remotely controlled. As alluded to above, outlet 300 may include any of the features of the outlet(s) disclosed in U.S. application Ser. No. 13/672,534, filed Nov. 8, 2012, the entire disclosure of which is herein incorporated by reference. For example, the outlet 300 may include a microprocessor 310 that runs software or an algorithm stored in memory 315. The microprocessor may be remote to outlet 300 and connected to outlet 300 via any suitable wired or wireless connection or the Internet cloud 140. The outlet 300 further includes a transceiver 320, which may include any of the features described in connection with transceivers 230 and 235 of FIG. 2. The outlet 300 may also include one or more sensors 370, which can include motion sensors, ambient light sensors, a camera, a microphone, moisture sensors, or any of the sensors described above with respect to the one or more sensors 240 of FIG. 2.

In some embodiments, the outlet 300 receives electrical energy via a power switch 330 supplied by line power via connection 350. The power switch 330 may be controlled by a microprocessor, e.g., a microprocessor 310, which may include any of the features described with respect to the microprocessor 210 of FIG. 2. The power switch 330 may be configured to connect or disconnect the line power to the outlet 300, including a connected load 360 (e.g., one or more electrical devices coupled to the outlet 300). The power switch 330 may be also configured to reduce a voltage or current delivered to the load 360, thus providing a dimming function.

The outlet 300 may further include a power monitor 340 for measuring the consumption of power by the load 360 connected to the outlet 300. The load 360 may be connected via any suitable means, such as, e.g., standard 2 or 3 pin power outlets, 220V outlets, or international standard outlets, and may also include a wireless connection such as via a wireless charger. The power monitor 340 may transmit measured power data to the microprocessor 310 via the transceiver 320, or any other suitable means, and may also transmit data to one or more other components or devices of the system 100.

In some embodiments, the power monitor 340 also measures noise in the connection to the load 360 in order to determine the type of energy-consuming device(s) connected, e.g., as explained in U.S. application Ser. No. 13/672,534, which is incorporated herein by reference. This type of analysis is discussed in U.S. Pat. No. 8,094,034, for example, also incorporated herein by reference. Multiple connections throughout an entire structure may be monitored and analyzed to determine the types of devices, such as appliances, connected to define the load 360, e.g., by turning the devices on and off. In some embodiments, user activity may be inferred by monitoring a structure, e.g., identifying which loads are activated and deactivated. By monitoring power consumption characteristics at the outlet 300, characteristics of a device connected to the outlet 300 may be determined, e.g., via techniques disclosed in U.S. Pat. No. 8,094,034, or other analytical methods. Based on the power consumption characteristics, the device (e.g., an oven, refrigerator, or fan) may be beneficially and intelligently identified and/or controller.

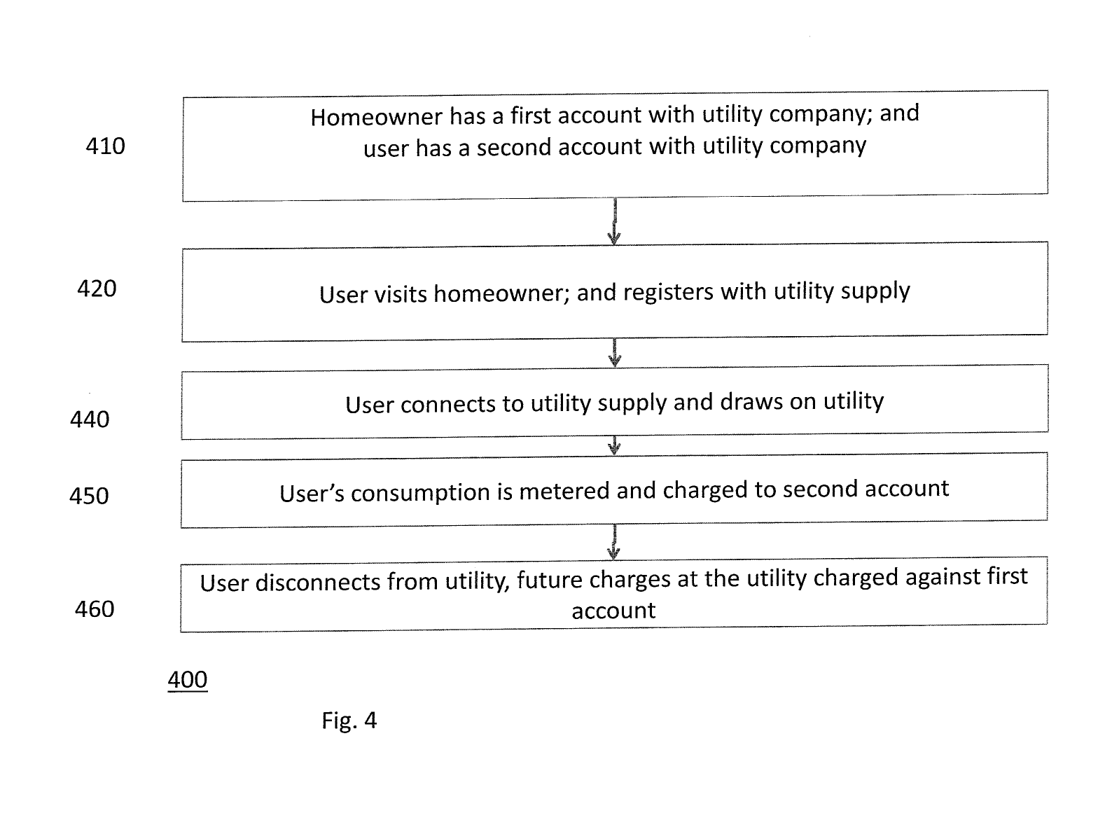

FIG. 4 depicts a flowchart 400 showing an exemplary embodiment of the present disclosure. The flow starts at step 410 with a first account holder, such as a homeowner having an associated first account with a utility company. The utility company may provide a utility to a location associated with the homeowner. Use of the utility may be tracked to the first account, and the homeowner may be billed for any usage. A user may have a second account with the utility company, such as, e.g., an electricity provider, a natural gas provider, a water provider, an internet service provider, or any other provider of a consumable that can be distributed and metered.

In one exemplary embodiment, the user visits a property of the home owner in control of a power supply that is associated with the first account. Utilities drawn and their associated charges may be, by default, linked to the first account. The user registers for a utility account (e.g., the second account), or associates an already existing second account with the property of the homeowner. For example, the user may manually enter his credentials for the second account in a device connected to system 100. In an alternative embodiment, a device controlled by or otherwise belonging to the user may connect with system 100, and transmit information about the second account to system 100. It should be noted that the homeowner/user relationship is only one example of a suitable relationship. That is, the present disclosure may be applied to any instance where an owner of a device consuming power (or some other utility) from an account not belonging to the owner of the device. For example, a sensor connected to system 100 may detect the user, via e.g., a camera and/or a microphone by sensing any combination of audio, image, and/or video which may be analyzed to determine the identity of the user using voice recognition, facial recognition, or other methods as are known in the art. System 100 may detect information about a device, such as e.g., a car or any other suitable device that belongs to the user. The device, which may be vehicle 180 (referring to FIG. 1), may have means to connect to system 100 directly or through Internet cloud 140 (also referring to FIG. 1), and vehicle 180 may pass at least some information about the identity of the user, vehicle 180, or the second utility account. The device may include any suitable identifying mechanism including, but not limited to RFID, optical data streaming capability, or the device may upload information to a network, which may send that information to a utility via the internet, for example. In one alternative embodiment, an outlet 130 may determine that a device has been plugged into or otherwise coupled to (e.g., by wireless or other means) outlet 130. The device may be identified from a characteristic of the power drawn by the device, from another sensor input such as a microphone or imager, or the device may communicate with system via a wired or wireless method to transmit the information to automation system 100, as alluded to above.

In step 440 the user may connect a device to draw on a utility. For example: The user may plug or otherwise couple vehicle 180 into the homeowner's electrical network to recharge vehicle 180; plug a computer into an outlet to recharge, connect a device to a network, and/or take a shower utilizing water and natural gas to heat the water. Normally, the cost of this usage would be charged to the homeowner's first account, and thus the homeowner would bear the cost burden for usage of any utilities by the user (e.g., a short-term or long-term visitor, tenant, employee, student, or other suitable relationship).

During step 450, the automation system 100 tracks the usage of the utility by the user, including usage by devices belonging to or associated with the user. The power consumed by the user through the power supply may be measured by a power monitor such as 340 (referring to FIG. 3), or by a power monitor associated with breaker box 105 (referring to FIG. 1). The device may additionally or alternatively be configured to self-measure power consumption, and report how much of a utility (or multiple utilities) is consumed by the device to system 100, to the utility, and/or to a third party. For example, vehicle 180 may measure how much power is pulled to recharge its batteries, and that measurement may then be sent to system 100, to the utility, or to a third party. In some embodiments, automation system 100 may thus determine if the energy drawn by vehicle 180, or any other device drawing power from the power supply is associated with the first account, the second account, or an alternative account. Once the amount of the utility consumed by the user or a device of the user is determined, that determined amount is charged (associated) to the second account instead of to the first account. It is contemplated that automation system 100 may be used with multiple users and devices drawing on multiple utilities (e.g., any combination of electricity, natural gas, internet, or other utility) at the same time. In such embodiments, charges may be made to a controlled, refillable, deposit account, such as a PayPal account, or the like.

Transferring the charge for utilities used can be accomplished many other ways. The user's device may send information to the utility or an agent of the utility causing the second account to be charged for the device's usage and the first account to receive a credit. An element of automation system 100, or an element connected or otherwise coupled to automation system 100 could use the credentials transferred in step 420 to cause the second account to be charged for the devices usage and the first account credited. Alternatively, the charge for the user's device utility usage may remain on the first account and the home owner may receive payment directly from the user, the utility, and/or a third party to cover the cost. The payment may be delivered by an e-commerce method, such as, e.g., PayPal or the like, as is known in the art.

During step 460, after the device disconnects from the outlet 130, any future utility usages at the outlet 130 may be charged to the homeowner's first account or to any other account of other users owning devices later coupled. Thus, the method depicted by flowchart 400 may enable a user to transfer charges for his use of a utility to his second account, even if he was using the utility at a location where utility usage may normally be charged to an account different then the users, such as, e.g., the homeowner's first account.

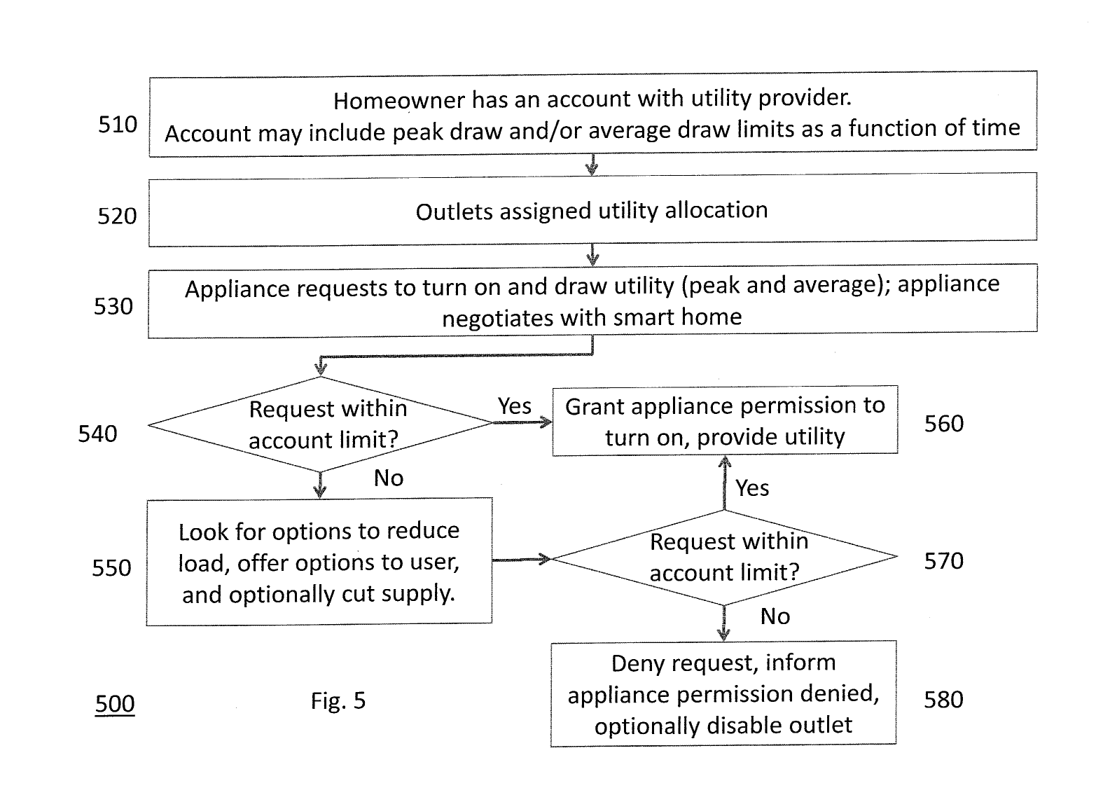

Turning to FIG. 5, flowchart 500 depicts an exemplary method to control a power consumed by a location. For example, peak power usage (especially rate of consumption at times of peak usage) is a known challenge for utility companies and consumers alike. Utility companies have already taken some steps to limit peak power usage. In one such step, air conditioning compressors may be controlled by an electric company to lock out or otherwise limit activation for certain times. For example, a given air conditioning compressor or group of compressors may be prohibited from activating for 15 minutes of a 60 minute span. When a large group of compressors are so controlled, the utility can significantly reduce the peak power load that would occur if all the compressors in an area of the electric grid cycle on at the same time during very hot weather. It is also expected that certain subdivisions, housing, or buildings may be powered by alternate energy sources such as wind, solar, tidal, geothermal, etc., which may have a hard limit on the amount of peak power that can be sourced. To prevent a brown out, a drop in delivered voltage which occurs when the load is greater than the source can provide, the utility customers may sign up for accounts which limit the peak power they are allowed to draw from the grid. The peak power may be dynamic and could change depending on for example, time, weather, tides, etc. The amount of peak power a user with an account is allowed to draw from the power grid may be predetermined, selectively adjusted by the utility or user, subdivision, condo building, building management, or other suitable entity, or may be communicated to the user such as through an electronic message sent from the utility to home automation system 100.

It is also contemplated that a usage limit may include an allocated power limit set by a person having authority over one or more subordinate figures. Exemplary authoritative/subordinate relationships include but are not limited to household relationships such as parent/child, or relationships found in assisted-living facilities and prisons. In these embodiments, an authority figure (e.g., parent, assisted-living facility manager, or prison warden) may set an allocated power limit for one or more subordinate figure(s) (e.g., a child, resident, or prisoner). The allocated power limit may be raised or lowered by the authority figure in response to variables controlled by the subordinate figure including, but not limited to a child's school grades, a resident's rental rate, and a prisoner's behavior. Should the usage total of a particular subordinate figure exceed the usage limit set for that subordinate figure, all further requests for power or utility by the subordinate figure may be denied. It is also contemplated that the account may automatically update based on such variables, or that the account may also be controlled as a function of time. For example, power to certain outlets linked to the subordinate may be disabled at certain times of the day, thereby allowing the authority figure to control behavior of the subordinate figures.

In step 510, a homeowner may have an account with a utility provider. The account may require that a user not exceed average or peak utility usage, and the limits may be fixed or dynamic as discussed. Exceeding the limits may result in the home owner paying increased rates for the utility or the limits may be hard and not to be exceeded. Alternatively, a subordinate figure may have an account with an authority figure that has an allocated power limit.

The usage of the utility may be monitored by a meter which may be part of breaker box 105 of system 100, or the usage of the utility may be monitored by outlet 130 and other devices connected to the utility such as controller 160 (referring to FIG. 1). The usage may also be monitored and metered by the device or appliance connected or otherwise coupled to outlet 130.

In step 520, an allocation of power may be assigned to an outlet, such as outlet 130 (referring to FIG. 1), and may be received by a controller. Other outlets with devices that are constantly or typically on such as clocks, medical devices, alarm systems, etc., may also be allocated power from the allowed peak power draw dictated by the terms of the home owner's account. The allocation may include average power draw, peak power draw, and/or allocated power limits. Alternatively or additionally, the allocation may be set as a function of time, a rate of consumption, or any combination of other suitable parameters as is known in the art. Typical usage of power may be learned over time and power may be allocated based on historical usage. For example: Power may be allocated to a coffee maker that typically runs every morning at 7 am, and other appliances such as, for example, air conditioning may be denied an allocation to prior to 7 am to allow the home owner to brew his morning coffee.

During step 530, an appliance (second device) may be turned on and may start to draw power. If the power drawn is within the limits allocated to the outlet (step 540), the outlet 130 may permit the appliance to run as in step 560. The controller may determine if a first device is drawing power, and if the appliance attempts to draw more power than allocated to the outlet 130 during step 540, the outlet 130 may request a larger allocation from system 100 or decrease access of any already-operating devices, including the first device, to the utility (step 550). It should be noted however, that system 100 may be prohibited from cutting power to critical devices including, but not limited to, refrigerators, medical devices, or other devices requiring an uninterrupted power supply. The request may be sent to the controller 110, breaker box 105, or another suitable element that is tracking and allocating power in the house. If the outlet 130 is granted the allocation, the appliance may be allowed to run. An element/component of system 100 may recognize the appliance from one or more characteristics of the power drawn by the appliance as described above, or from another sensor or user interface input to system 100. Based on recognizing the appliance, the power needs of the appliance can be determined from a database located in the system 100 or in a server located in the cloud and requested for an allocation.

The appliance may be a smart appliance which may be configured to draw a minimal amount of power, then the appliance may negotiate with the automation system 100 to request more power. The appliance may request an allocation for its known peak power usage, and the request may include a time the allocation is needed for. The request may also include average power needed. By way of example, a dishwasher may draw a very small amount of power to run a small microprocessor. When the user loads the dishwasher and turns it on, the dishwasher may communicate with system 100 and request power per the specification of the dishwasher for a timeframe associated with the cycles or other use-parameters selected by the user. The power requested may be a complex profile including for example a first power need for a first time for a wash cycle, followed by a second power need for a second time for a rinse cycle, followed by a third power need for a third time period for a dry cycle. The system 100 may grant the allocation immediately and the dishwasher may start to run, may grant the allocation with a time delay and the dishwasher may wait the delay and then run, or may reject the allocation in which case the dishwasher would not run. In the embodiment where system 100 may grant the allocation with a time delay, granting access to the utility immediately may cause a usage total to exceed a usage limit, while granting the request after the time delay would not cause the usage total to exceed the usage limit at that future time. In some exemplary embodiments, a message would be sent to the user if the dishwasher request was rejected.

If the system 100 has allocated all available power and the request to run an appliance cannot be met without exceeding limits of utility usage, then during step 550, the automation system 100 may consider options to reduce other usage. By way of example, the Heating Ventilation and Air Conditioning (HVAC) system may by temporarily turned off, the fan associated with the HVAC system may run at a reduced speed, a TV may be deactivated, clocks may be temporarily turned off, other lights in the building may be dimmed or deactivated to free up enough power to allow the appliance to run. The rules to determine what can be shut off or dimmed may be predetermined, may be partially or completely determined by the user, and the rules may be at least partially loaded from a server on the cloud. For example, the user may assign a priority ranking to particular outlets and/or appliances to allow system 100 to disable preselected devices without further instruction. In one exemplary embodiment, the user may assign priority to a dishwasher relative to a television, and thus, any request to activate the dishwasher may automatically shut off the television if doing so would enable system 100 to provide the dishwasher with the requested power draw. Additionally, the user may also set a restriction to prevent other devices from being shut off. For example, the user may prevent shutdown of, e.g., a refrigerator or a home security system. In some embodiments, critical devices will not be turned off in any circumstance. This restriction may be preprogrammed, or may alternatively be determined based upon the power draw characteristics of the restricted devices. If sufficient power can be made available by disabling other devices at step 570, then the appliance is allowed to turn on and operate.

If sufficient power is not available (step 580) to run the appliance, then the appliance may be requested to turn off or limit power draw, or system 100 may order a connected outlet to switch off power to the appliance. If the appliance is not allowed to run, the user may be notified that sufficient power is not available. The user also may be requested to reduce other usage to free up power for the requested appliance or the system may suggest alternative times to run the appliance based on predicted reductions in power consumption.

By way of example, a family of four: Mom, Dad, Johnny, and Sue, have a morning routine. Dad shaves every morning (using an electric shaver drawing power), while Mom is in the shower (the water heated by an electric heater), while Sue is drying her hair (using a super deluxe 2000 W hair dryer). Simultaneously, Johnny has oatmeal warming up in the microwave, and further decides to have some toast. The usage of the shower heater, shaver, microwave, and hair dryer may result in a cumulative energy usage total that is close to the allowed peak energy usage the family's account permits during the morning rush hours. If, for example, Johnny were to attempt to activate the toaster while the other appliances were operating, the toaster may remain off and unpowered until at least one of the other items (shaver, shower heater, hair dryer, microwave) finishes operating. For the example, once the oatmeal is done, the microwave's power usage is greatly reduced, and system 100 may permit the toaster to start functioning. Further, if Sue has the TV on, and the toaster requests power while having a priority over the TV, and powering the toaster would put the power consumption of the family in excess or its usage limit, the TV may automatically be powered off so that the toaster may be powered on.

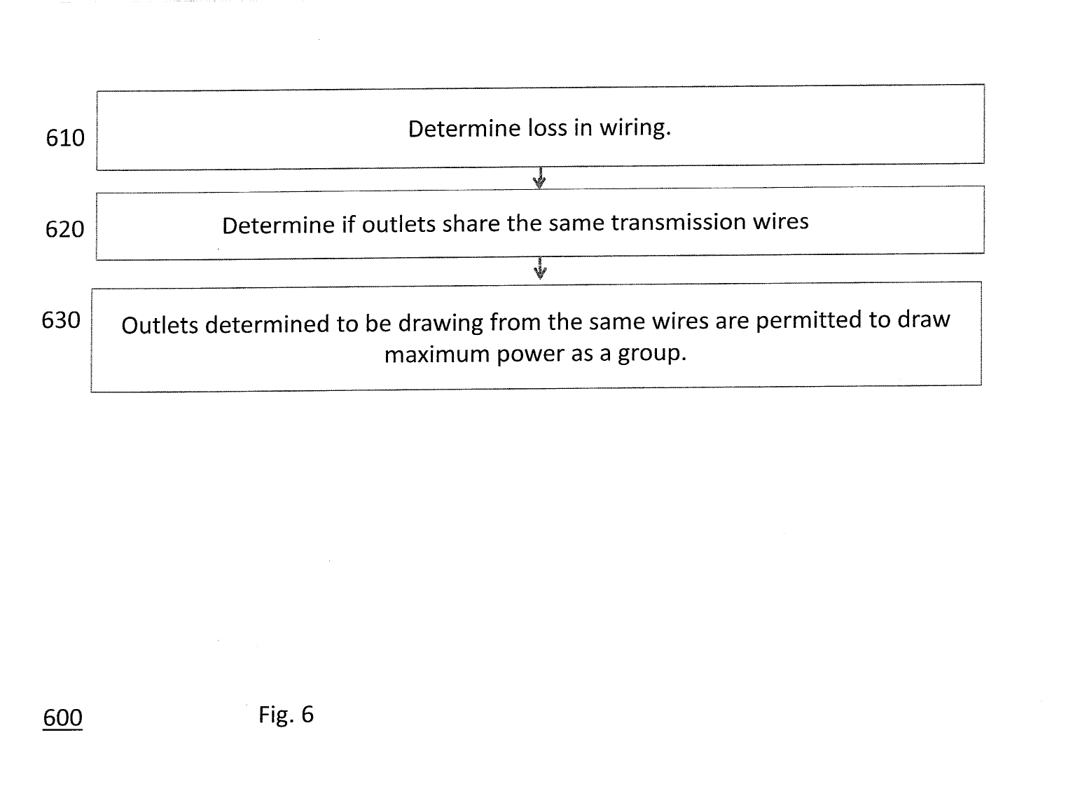

FIG. 6 depicts a flowchart 600 showing an exemplary method where home automation system 100 determines in step 610 a voltage loss in wires 123 and/or 124 (referring to FIG. 1) used to deliver power to a building. The loss may be determined by measuring the voltage of wire 123 at both breaker box 105 and at outlet 130. By determining the voltage drop of wire 123 between breaker box 105 and outlet 130, and by knowing the power supplied to the outlet 130, the resistance of the wire 123 may be determined.

During step 620, the system 100 may determine if multiple outlets are sharing the same wires 123. For example, if a first and second outlet are sharing wires 123, and a third outlet is on a different wire, when a load connected to first outlet turns on, the first and second outlets will both note a drop in the voltage supplied to the first and second outlet. The third outlet will not notice a drop in voltage coincident with the load connected to the first outlet drawing power. System 100 can collect information about instantaneous supply voltage readings and load activity and build a list of which devices share wiring.

Once the system 100 understands which outlets share wiring, allocations given to a group sharing a wiring source may be limited, as in step 630. If the first and second outlets share a wire 123, the total amount of power allocated to the first and second outlet (e.g., a maximum load supportable by the wire) may be limited by the amount that can be sourced by the wire. For example, if the first outlet has a space heater plugged in that is drawing 30 Amperes, the system 100 may determine that the wire 123 can source no more than 30 Amperes, or the circuit breaker connected to the switch 123 in breaker box 105 may be limited to 30 Amperes. In either case, a vacuum cleaner plugged into the second outlet may be prevented from operating by the outlet disabling power to the vacuum, until the space heater is turned off or draws less power so that the limits of the wiring or circuit breakers are not exceeded.

Thus, an automation system 100 in accordance with the present disclosure may determine that power drawn from an outlet should be charged to a different account. System 100 may also limit operation of appliances to conform to at least one of a peak power limit, an average power limit, or an allocated power limit. The system 100 may also limit power drawn by a circuit defined by a breaker or by physical wiring or wireless transmission limits to source power to multiple outlets or devices so that the circuit, or wiring, is not overloaded.

In an embodiment, multiple users may have individual and joint devices. For Example: Two college students sharing an apartment may decide to split the electricity cost for HVAC, while energy costs for cooking, computers, and entertainment equipment may be individually tracked and billed to the individual student.

In another embodiment, a homeowner Bob has an account with utility company A. Friend Jeff has an account with utility company B. When Jeff charges a battery of his car when visiting Bob, an account for Jeff on utility company A may be automatically opened to facilitate charging for costs for charging his car. In some exemplary embodiments, a person affiliated with utility A (e.g., Bob) may be reimbursed by utility B, which may ultimately charge the user (e.g., Jeff).

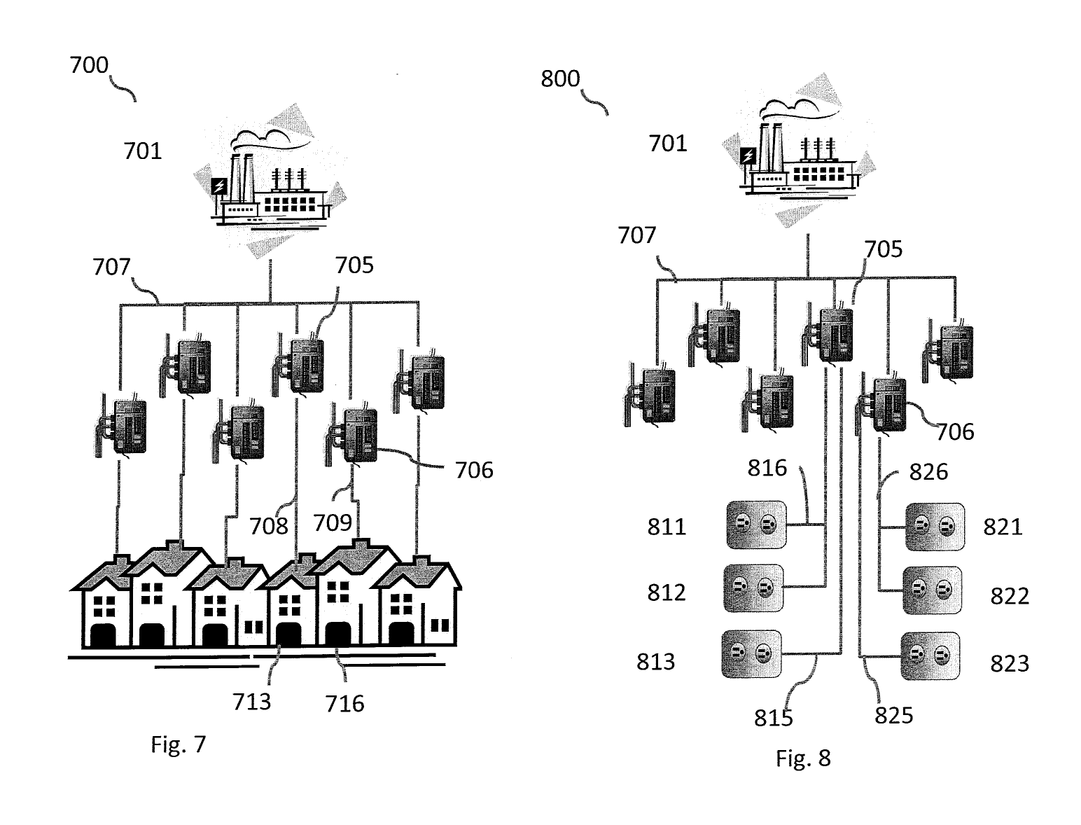

FIG. 7 is a schematic of an exemplary power system 700 that may distribute power to a multi-unit structure. While the example is for electrical power, the functions apply to any utility that may be distributed. Power may be generated in a power plant 701, and transmitted over power lines 707 to individual meters 705 and 706. At least one line 708 transmits power from a meter 705 to unit 713, and a line 709 transmits power from meter 706 to unit 716. Thus, each unit has an individual meter to facilitate charging the occupants of each individual unit for the utility. The units could be part of a condominium, a townhouse, an apartment building, an office building, store units of a strip mall, or any other suitable building where individual meters are assigned to individual units.

FIG. 8 is a schematic of power system 800 showing individual outlets within the units depicted by FIG. 7. For example, outlets 811, 812, and 813 may be deployed within unit 713 (referring to FIG. 7), while outlets 821, 822, and 823 may be deployed in unit 716. From meter 705, wire 816 transmits power to outlets 811 and 812, while wire 815 conducts power to outlet 813. Wires 816 and 815 represent individual wires, or circuits, which may have one of more devices connected. The devices could be outlets, lights, or other appliances which may be connected to draw electrical power. Similarly, wire 826 connects meter 706 to outlet 821 and outlet 822, while wire 825 connects meter 706 to outlet 823.

Should the multi-unit dwelling be reconfigured, for example, by combining individual units 713 and 716, as is often executed in a store front, the meters 705 and 706 associated with individual units 713 and 716 would need to be rewired to allocate and monitor power to the combined unit. If unit 713 was subdivided, such as a home subdivided to break out a basement room as an apartment, expensive wiring would need to be contracted to add a meter and facilitate setting up a utility account for the separation. For example 811 and 812 may be part of the upper levels, while 813 may be in the basement and would be desired to be separately metered for a tenant in the new basement apartment.

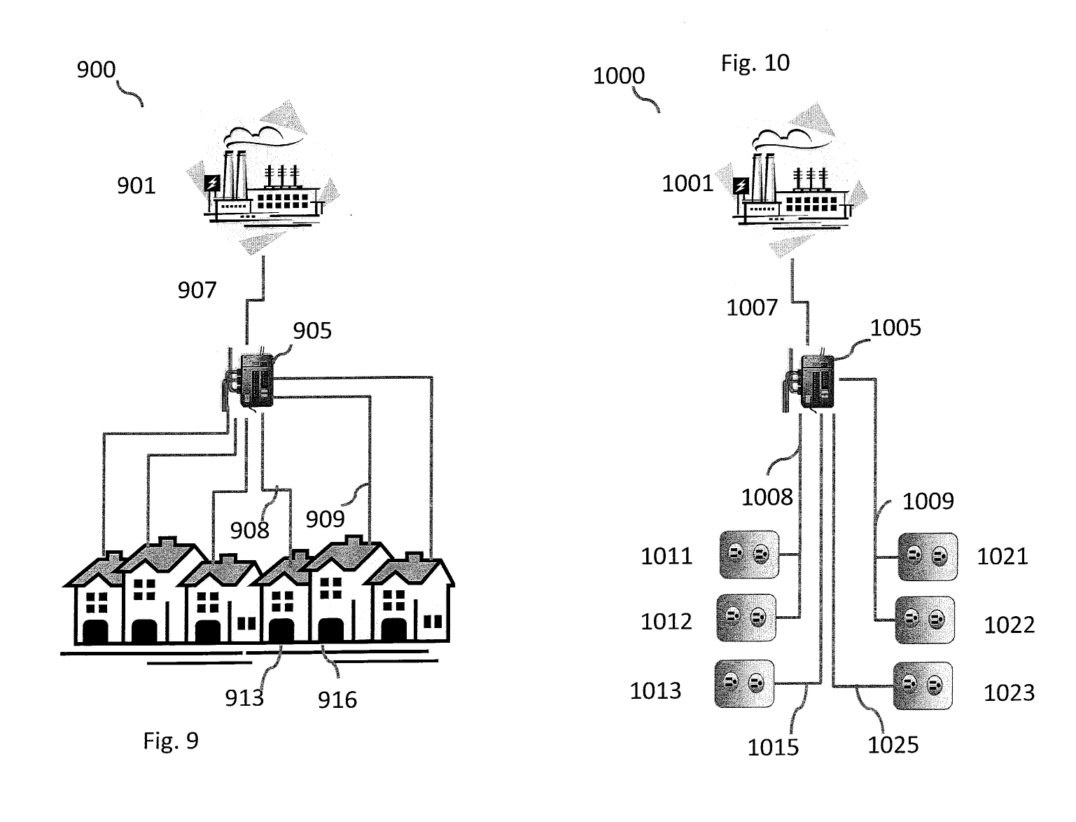

FIG. 9 is a schematic illustration of an exemplary power system 900 for distributing electrical power. Power plant 901 delivers electrical power to a breaker box 905 through power transmission wires 907, or alternatively by wireless or other suitable means. Breaker box 905 may additionally or alternatively include an electrical meter, or a cut off switch to allow the interruption of electrical power. Alternatively, breaker box 905 may be eliminated and power may be transmitted directly into the units of a multi-unit structure such as units 913 and 916. Power is delivered to unit 913 wirelessly or by wires 908, and power is delivered to unit 916 by wires 909. Compared to the methods shown in FIGS. 7 and 8, power system 900 may eliminate a significant number of meters, reducing cost and complexity. A first account may be configured to track all power delivered to unit 913, while a second account may be configured to track all power delivered to unit 916. It is further contemplated that any additional number of accounts may be configured to track power delivered to any additional number of units in a multi-unit structure, or units sharing breaker box 905.

FIG. 10 is a schematic illustration of a power system 1000 depicting the distribution of electrical power within two units of a multi-unit structure. Power plant 1001 generates electrical power and transmits the power via transmission wires 1007 to device 1005. Device 1005 may be similar to device 905 and may be an electrical meter, a breaker box, a cutoff switch or the like. Alternatively, device 1005 may be eliminated, allowing wires 1008, 1009, 1015, and 1025 to connect directly to wires 1007. In some embodiments, power may be transmitted wirelessly. Wires 1008 and 1015 are within unit 913, while wires 1009 and 1025 are within unit 916. Outlets 1011 and 1012-receive electrical power via wire 1008, while electrical power is received by outlet 1013 via wire 1015.

Outlets 1011-1013, and outlets 1021-1023 may be electrical outlets similar to outlet 300 (referring to FIG. 3), or they may be other smart devices capable of measuring power transmitted to a load. In FIG. 10, the outlets 1011-1013 and 1021-1023 would track how much energy is delivered for purposes of accounting and billing. For example, if George is the person residing in unit 913, he may have devices 1011, 1012, and 1013 registered to him. Any power delivered to appliances connected to outlets 1011-1013 would be metered by outlets 1011-1013, and George would be charged for the use. Meanwhile in unit number 916, Tom lives on the main level where outlets 1021 and 1022 are registered to him. Paul resides in the basement of 916, and outlet 1023 is registered to Paul. Thus, by metering power at the device level, such as at a smart outlet, instead of metering power at the input or entry to a unit, the power consumed can be dynamically charged to the account of the person plugging appliances into the respective outlets.

In storefronts, different portions of a building may be used for individual stores as a business expands or goes out of business. By dynamically assigning the device or appliance usage to accounts belonging to the user(s) responsible for the device or appliance, costly charges of rerouting wiring is avoided. In FIG. 9, a business, such as, e.g., a restaurant may be located in unit 913, and as the business grows, it may expand into unit 916. When the business expands, outlets 1021-1023 can be remapped to the restaurant's utility account, and power used by restaurant would be charged to the restaurant owner without requiring wires to be changed.

The examples have depicted distribution methods for electrical power, but may be applied to any distributed resource or utility such as steam, heat, natural gas, water, liquid propane gas (LPG), oxygen, nitrogen, other gases, or any other utility or consumable that is capable of being metered to individual users.

It is understood that the present disclosure is not limited to the particular forms, embodiments and examples illustrated. The method and apparatus of the disclosure can be practiced with and modifications and variations that do not depart from the spirit and scope of the disclosure.

Embodiments of the present disclosure may be used in connection with any structure, including, but not limited to, homes, offices, business, schools, churches, sporting complexes. In addition, at least certain aspects of the aforementioned embodiments may be combined with other aspects of the embodiments, or removed, without departing from the scope of the disclosure.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

1-13. (canceled)

14. A method of limiting utility usage, comprising:
receiving a usage limit;
receiving a request to access the utility;
determining if granting the request will cause a usage total to exceed the usage limit; and
granting or denying access to the utility based on whether the request will not cause or cause, respectively, the usage total to exceed the usage limit.

15. The method of claim 14, wherein the usage limit is at least one of a peak usage, an average usage, an allocated usage, and a maximum load supportable by a delivery circuit.

16. The method of claim 14, wherein, if the usage total exceeds the usage limit, automatically denying all requests to access the utility.

17. The method of claim 15, wherein the allocated usage limit is a limit set by an authority figure for a usage total consumed by a subordinate figure.

18. The method of claim 17, wherein the authority figure sets a plurality of allocated usage limits for a corresponding number of subordinate figures.

19. The method of claim 17, further including:
determining if a first device is consuming the utility; and
decreasing access of the first device to the utility if the request for accessing the utility is made by a second device.

20. The method of claim 19, further including decreasing access of the first device to the utility if the usage total is below the usage limit after both the second device is allowed to draw on the utility and the access of the first device to the utility is decreased.

21. The method of claim 19, further including decreasing access of the first device to the utility if the second device is assigned an operating priority over the first device.

22. The method of claim 19, further including granting access to the utility on a time delay if granting the request immediately will cause the usage total to exceed the usage limit but granting the request after the time delay will not cause the usage total to exceed the usage limit.

23. The method of claim 19, further including prohibiting decreasing access of the first device to the utility if the first device is determined to require an uninterrupted utility supply.

24. A system for limiting utility usage, comprising:
a controller configured to:
receive a usage limit;
receive a request to access the utility;
determine if granting the request will cause a usage total to exceed the usage limit; and
grant or deny access to the utility based on whether the request will not cause or cause, respectively, the usage total to exceed the usage limit.

25. The system of claim 24, wherein the usage limit is at least one of a peak usage, an average usage, an allocated usage, and a maximum load supportable by a delivery circuit.

26. The system of claim 24, wherein the controller is further configured to:
determine if a first device is consuming the utility; and
decrease access of the first device to the utility if the request for accessing the utility is made by a second device.

27. The system of claim 26, wherein the controller is further configured to decrease access of the first device to the utility if the usage total is below the usage limit after both the second device is allowed to draw on the utility and the access of the first device to the utility is decreased.

28. The system of claim 26, wherein the controller is further configured to decrease access of the first device to the utility if the second device is assigned an operating priority over the first device.

29. The system of claim 26, wherein the controller is further configured to grant access to the utility on a time delay if granting the request immediately will cause the usage total to exceed the usage limit but granting the request after the time delay will not cause the usage total to exceed the usage limit.

30. The system of claim 26, wherein the controller is further configured to prohibit decreasing access of the first device to the utility if the first device is determined to require an uninterrupted utility supply.

31. The system of claim 24, wherein the controller is further configured to automatically deny all requests to access the utility if the usage total exceeds the usage limit.

32. The system of claim 25, wherein the allocated usage limit is a limit set by an authority figure for a usage total consumed by a subordinate figure.

32. The system of claim 25, wherein the authority figure sets a plurality of allocated usage limits for a corresponding number of subordinate figures.

33. The method of claim 17, further including:
updating the allocated usage limit based on variables controlled by the subordinate figure.

34. The method of claim 33, wherein the update may be automatic or controlled as a function of time.

35. The method of claim 19, wherein the decreased access of the first device includes terminated access.

36. The method of claim 14, further comprising:
receiving a request to change the usage limit if the request to access the utility exceeds the usage limit.

37. The method of claim 14, wherein the utility is electrical energy and the request to access includes an electrical characteristic of a device.

38. The method of claim 37, wherein the request to access further includes a time allocation or power amount based on the electrical characteristic of the device.

39. The method of claim 14, wherein the usage limit is based on a historical usage or an availability of an energy source.
